(19) United States
(12) Patent Application Publication
(10) Pub. No.: US 2012/0024316 A1
(43) Pub. Date: Feb. 2, 2012

(54) SUCTION CUP FOR A MOBILE CLEANING DEVICE AND A MOBILE SUCTION SYSTEM WITH SUCH A SUCTION CUP

(76) Inventor: Christian Reining, Deutschland (DE)

(21) Appl. No.: 13/093,623

(22) Filed: Apr. 25, 2011

(30) Foreign Application Priority Data
Jul. 21, 2010 (EP) 10007540.7

(51) Int. Cl. A47L 9/20; B08B 5/04; A47L 5/00; A47L 9/24; A47L 9/02

(52) U.S. Cl. 134/6; 15/246.2; 15/300.1; 15/339; 15/363; 15/383

(57) ABSTRACT

A suction cup for a mobile cleaning device for cleaning a hose filter. The suction cup has a base body with an outer circumference secured with respect to the hose filter. And, the suction cup has a through-opening with an inner circumference and a longitudinal axis. The suction cup also has a first felt seal secured with respect to the base body outer circumference, and a second felt seal secured with respect to the through-opening inner circumference.

### CROSS-REFERENCE TO RELATED APPLICATION

This application is a continuation of European Patent Application Serial No. 10007540.7, filed Jul. 21, 2010, the entirety of which is hereby incorporated herein by reference for all purposes.

### TECHNICAL FIELD

The present invention relates to a suction cup for a mobile cleaning device for cleaning hose filters, with a base body which has an outer circumference, which matches the inner circumference of a hose filter opening, and a longitudinal axis. The present invention also relates to a suction system with such a suction cup and to a cleaning device with a suction system and a suction cup, and finally to a method for cleaning horizontally installed hose filters using the suction cup, suction system and cleaning device.

### BACKGROUND

Suction cups for a use for cleaning hose filters are not known from the prior art. Suction devices are regularly positioned only in the vicinity of a hose filter opening to extract a dust fraction in the air which occurs there during the cleaning process. To this end, suction systems are used which are known from technical fields in which relatively large amounts of dust are regularly produced during material processing, which dust must be extracted. For example, such suction devices are known in wood processing. In a mobile use for hose filter cleaning, the free end of a suction hose is simply positioned in the vicinity of the hose filter opening.

The suction systems known from the prior art do not form a unit with a cleaning device during operation, as they are not physically connected to each other. In cleaning devices, rotating cleaning heads are generally used, which are difficult to handle when cleaning horizontally installed hose filters when there is no unit between the suction system and the cleaning device. Needs exist for a suction cup for a mobile cleaning device.

### SUMMARY

It is to the above-described needs that the present invention is directed. The present invention can create a suction cup, which during operation forms a connection between a suction system and a cleaning device and allows cleaning of hose filters which is essentially dust-free with respect to the environment.

In a first example embodiment a first felt seal is applied to the outer circumference and the base body has a through-opening for a cleaning element, wherein a second felt seal is applied to the inner circumference of the through-opening.

With the suction cup according to the invention it is possible to produce a leakproof connection between an inner circumference of a hose filter opening and an outer circumference of the base body of the suction cup. It is also possible to produce a leakproof connection between a cleaning element and the base body of the suction cup. The suction cup can thereby form a sealing coupling element for a cleaning device during operation, as part of a suction system or in connection with a suction system. It is also made possible for the cleaning element in the through-opening of the base body to receive a guide which ensures a controlled path of movement. This is significant in particular for the cleaning of horizontally installed hose filters.

A further advantage of the present invention is that the through-opening runs parallel to the longitudinal axis of the base body. The guide length of the through-opening for the cleaning element is optimised by this measure. This is also particularly advantageous when cleaning horizontally installed hose filters. This is however also advantageous for vertically installed hose filters.

A further advantage of the present invention is that the base body is divided into an upper cup part and a lower cup part in a plane transverse to the longitudinal axis, the first felt seal being applied to the outer circumference of the lower cup part. The division of the base body into an upper cup part and a lower cup part makes it possible to adapt the suction cup to different hose filter diameters. It is therefore not necessary to keep the whole suction cup in different sizes. Rather, it is sufficient to keep a series of different lower cup parts in order to carry out an adaptation to the respective hose filter opening.

A further advantage of the present invention is that the lower cup part has a head plate to which a third felt seal is applied in order to form a seal between the head plate and a base plate of the upper cup part.

The third felt seal ensures that no dust particles can exit at this connection point either.

A further advantage of the present invention is that the first felt seal has a variable thickness in order to be able to seal different hose filters and supporting bodies. This measure means that identical lower cup parts can be brought to different outer diameters in order to be adapted to the respective inner diameter of a hose filter opening.

A further advantage of the present invention is that the base body has a connection for a suction system. The suction cup can be handled separately from a suction system thanks to this measure. This makes the mobile use of the suction cup easier, for example when changing between cleaning of horizontally installed and vertically installed hose filters.

The invention is also achieved by a suction system with a suction cup according to the invention. It is particularly advantageous if the suction system is configured to be mobile. Then horizontally installed and vertically installed hose filters can be cleaned on site practically in the same manner and with the same system.

A further advantage of the present invention is that the suction system has an earth cable for preventing static charge. This ensures that all the dust particles are extracted and do not adhere to the unit and/or to parts of the unit due to static charge.

A further advantage of the present invention is that a control unit for controlling the operation of the system has a foot pedal for activating and deactivating the suction system. By activating and deactivating the suction system by means of a foot pedal, the user can keep his/her hands free in order for example to operate a cleaning device.

The invention also includes a cleaning device with a suction system according to the invention and a suction cup according to the invention.

It is also advantageous for the cleaning device to be mobile. Then it can be used with the mobile suction system and the separate suction cup for any use for cleaning hose filters, regardless of whether they are horizontally installed or vertically installed.

A further advantage of the present invention is that a cleaning element is guided through the through-opening of the suction cup and can be moved back and forth. The actual coupling between the cleaning device, suction system and hose filter takes place by means of this measure. Cleaning can be carried out without dust getting into the environment thanks to the leakproof connection of the suction cup to the hose filter and of the suction cup to the cleaning element. The whole piece of equipment can thereby also be used in cleanrooms or at least in rooms to be kept largely dust-free.

A further advantage of the present invention is that a cleaning head with at least one cleaning nozzle is arranged at the free end of the cleaning element. A cleaning nozzle allows a controlled volumetric flow for cleaning a dirty hose filter. It is particularly advantageous that the cleaning head and/or the at least one cleaning nozzle is set in rotation during operation. Such rotary nozzles, as they are known, allow optimal cleaning over the entire circumference of the hose filter.

The invention further includes a method for cleaning horizontally installed hose filters. It has not been previously known to use rotary nozzles for horizontally installed hose filters. Cleaning with a rotary nozzle is however possible without dust escaping into the environment even with horizontally installed hose filters with the suction cup, suction system and cleaning device according to the invention.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

An exemplary embodiment of the present invention is described in more detail below using the drawings. In the figures:

FIG. 1 shows a schematic view of a cleaning device, suction cup, suction system according to the present invention;

FIG. 2 shows a perspective view of a suction cup according to the invention with different lower cup parts; and

FIG. 3 shows a perspective view of an upper cup part of the suction cup in FIG. 2, according to the present invention with a through-opening for a cleaning element with a felt seal.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

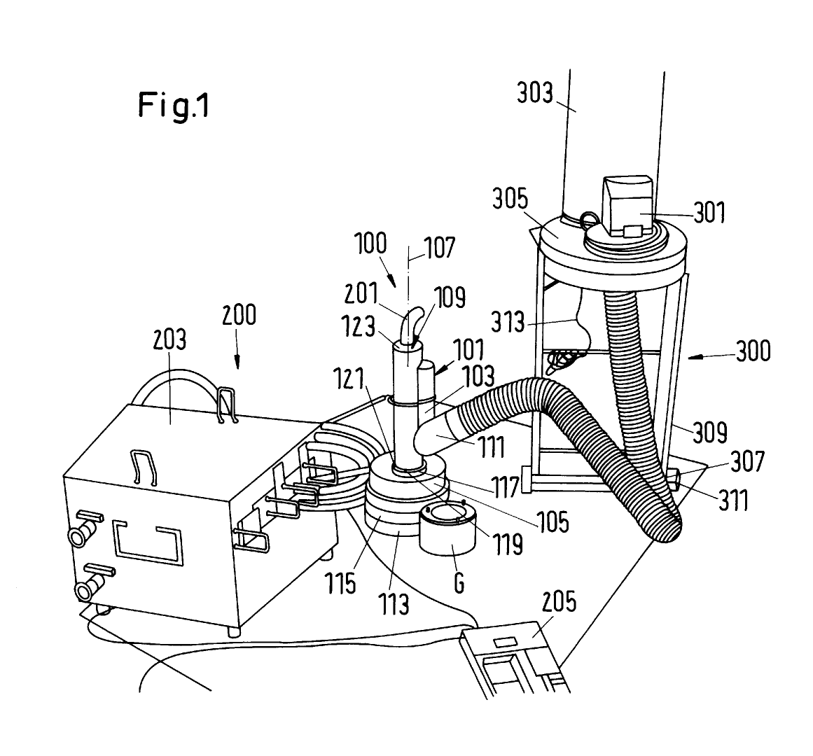

With reference now to the drawing figures, wherein like reference numbers represent corresponding parts throughout the several views, FIG. 1 schematically shows a complete piece of cleaning equipment. The cleaning equipment comprises a suction cup 100, a suction system 200 and a cleaning device 300.

The suction cup 100 has a base body 101 which in the present embodiment is composed of an upper cup part 103 and a lower cup part 105. In other embodiments, the base body 101 can also be composed in one part or from any number of parts. The base body 101 has a longitudinal axis 107. A through-opening 109 runs through the base body 101 parallel to the longitudinal axis 107 and in the present embodiment also concentrically to the latter (see FIG. 3). The through-opening 109 runs through the entire base body 101, that is, both the upper cup part 103 and the lower cup part 105.

A connecting piece 111 for connecting the suction system 300 is formed laterally on the base body 101 and in the present embodiment on the upper cup part 103. The connecting piece 111 extends at an angle to the longitudinal axis 107, so that an acute angle is enclosed between the base body 101 or the upper cup part 103 and the connecting piece 111. It can be seen in FIG. 1 that the connecting piece 111 runs diagonally upwards in relation to the base body 101 when the suction cup 100 is aligned in its operating function for cleaning a vertically installed hose filter. When the suction cup is arranged to clean a horizontally installed hose filter, the connecting piece 111 would point diagonally backwards.

A first felt seal 113 is applied to the base body 101 and in the present embodiment to the lower cup part 105. The first felt seal 113 completely surrounds the lower cup part 105. The first felt seal 113 is fixed for example by adhesive or else in an advantageous manner mechanically with the aid of a clamping element 115. The lower cup part 105 has a head plate 117 and the upper cup part 103 has a base plate 119 which abuts the head plate 117. A second felt seal 121 is attached between the head plate 117 and the base plate 119.

A third felt seal 123 is attached in the through-opening 109 (see FIG. 3). The third felt seal 123 surrounds the inner diameter of the through-opening 109 in an entry region for a cleaning element.

The lower cup part 105 is attached such that it can be replaced with respect to the upper cup part 103, for example by screw-fastening. FIG. 1 shows another lower cup part G which has a smaller outer diameter than the lower cup part 105. The suction cup 100 as a whole can be adapted to a different inner diameter of a hose filter by connecting different lower cup parts 105/G to the upper cup part 103. Further adaptation is possible if the thickness of the first felt seal 113 is varied.

FIG. 1 also shows the suction system 300. The suction system 300 comprises a conventional suction device with an electric motor 301 and a collection bag 303. A suction hose 307 is arranged between a housing 305, to which the electric motor 301 is attached, and the connecting piece 111 of the suction cup 100. The suction hose 307 is flexible and can be stretched in length to a certain extent. The suction hose 307 is connected to the connecting piece 111 by usual connection elements, for example hose clamps. In the connected state the suction cup 100 forms a connection piece of the suction system 300 for connecting to a hose filter. The suction system 300 comprises wheels 311 on its housing 309 so that it is mobile. The suction system 300 also comprises an earth cable 313 with which static charge is prevented.

The cleaning equipment also comprises a cleaning device 200 with a cleaning element 201 which in the present case is a cleaning hose. In other embodiments, the cleaning element 201 can also be a fixed rod.

The cleaning hose 201 is flexible and connected to a control unit 203. The control unit 203 comprises a usual electric device for opening and closing a compressed air supply and for activating and deactivating the cleaning device and where necessary also the suction system 300.

A foot pedal 205 is provided for operating the control unit 203. The foot pedal 205 is connected to the control unit 203 via electric cables, the control unit 203 in turn being connected to the suction system 300 where necessary via electric cables (not shown). The compressed air supply can be switched on or off on the one hand and the cleaning device and/or the suction system can be activated or deactivated on the other hand by actuating the foot pedal 205. Of course, the control unit can also comprise a multiplicity of other functions which can at least partially be switched on or off by means of the foot pedal 205. The control technology is state of the art and does not form the subject matter of the present invention. A cleaning head (not shown) with at least one cleaning nozzle is attached to a free end of the cleaning element 201. In the present embodiment, the cleaning head or the at least one cleaning nozzle should rotate during operation. Of course, non-rotating cleaning heads or cleaning nozzles can also be used in other embodiments.

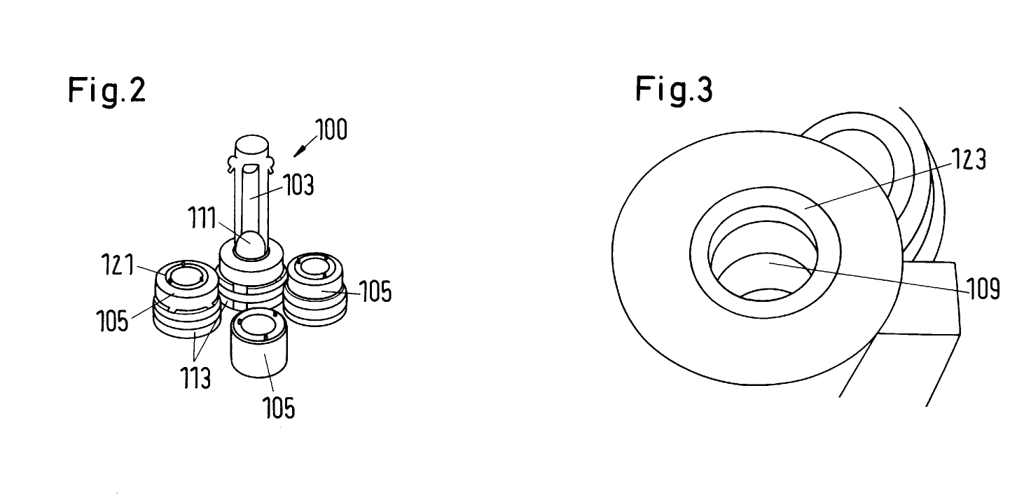

FIG. 2 schematically shows the suction cup 200 with different lower cup parts 105. FIG. 3 schematically shows how the third felt seal 123 is arranged in the region of the entry of the cleaning hose 201 on the inner circumference of the through-opening 109 of the upper cup part 103 or base body 101. By varying the thickness of the felt seal 123 it is possible to produce a seal with respect to cleaning elements 201 of differing thickness. FIG. 2 also clearly shows the second felt seal 121.

For a cleaning process, the suction system 300 is connected to the suction cup 100 and to the cleaning device 200. The mobile suction system 300 according to the invention has a maximum volumetric flow of 1100 m²/h at a pressure of 1750 Pa. Residual dust from the filter hoses is not released but extracted. The cleaning hoses 201 are designed for a pressure of up to 20 bar. There is a maximum temperature resistance of 180° C. Cleaning of filter systems in the high-temperature range in N-1 operation (without stopping) is thus also possible. The compressed air hoses have a steel mesh liner and are additionally earthed by means of earth cables. Earthing is thus provided here too to prevent static charge and sparks. The control unit 203 has a foot pedal 205 for each cleaning head (not shown) and thus each suction system 300.

To carry out cleaning, the cleaning element 201 of the cleaning device 200 is introduced through the suction cup and the hose filter opening into the hose filter. The control unit 203 is then activated and the cleaning element 201 is moved in the hose filter, for example moved back and forth. After the cleaning process is finished, the control unit 203 is deactivated, for example by means of the foot pedal 205. The cleaning element 201 is then pulled out of the hose filter. The suction system 300 is then removed from the hose filter by pulling the suction cap 100 out of the hose filter opening.

When cleaning horizontally or vertically installed hose filters, cleaning elements with rotary nozzles are used in the present embodiment. Rotary nozzles are generally known from the prior art and do not form part of the present invention.

While the invention has been described with reference to preferred and example embodiments, it will be understood by those skilled in the art that a variety of modifications, additions and deletions are within the scope of the invention, as defined by the following claims.

What is claimed is:

1. A suction cup for a mobile cleaning device for cleaning a hose filter, the suction cup comprising:
a base body comprising an outer circumference secured with respect to the hose filter, a through-opening comprising an inner circumference and a longitudinal axis,
a first felt seal secured with respect to the base body outer circumference, and
a second felt seal secured with respect to the through-opening inner circumference.

2. The suction cup of claim 1, wherein the through-opening is extends parallel with respect to the base body longitudinal axis.

3. The suction cup of claim 1, wherein the base body comprises an upper cup and a lower cup in a plane transverse to the longitudinal axis, the lower cup and upper cup each comprising an outer circumference, wherein the first felt seal is secured with respect to the outer circumference of the lower cup.

4. The suction cup of claim 3, wherein the lower cup comprises a head plate and the suction cup further comprises a third felt seal, wherein the third felt seal is secured with respect to the head plate and a base plate of the upper cup.

5. The suction cup of claim 1, wherein the first felt seal comprises variable thickness to seal different hose filters and supporting bodies.

6. The suction cup of claim 1, wherein the base body comprises a connection member for a suction system.

7. A suction system of claim 1 with a suction cup comprising:
a base body comprising an outer circumference corresponding with an inner circumference of a hose filter opening, an aperture for receiving a cleaning element, and a longitudinal axis;
a first felt seal secured with respect to the base body outer circumference; and
a second felt seal secured with respect to the aperture inner circumference.

8. The suction system of claim 7, wherein the system is mobile.

9. The suction system of claim 7, wherein the system comprises a maximum volumetric flow of 1100 m³/h at a pressure of 1750 Pa.

10. The suction system of claim 7, further comprising an earth cable for preventing static charge.

11. The suction system of claim 7, further comprising a control unit for controlling the operation of the system, wherein the control unit comprises a first foot pedal for activating and deactivating the suction system.

12. The suction system of claim 7, further comprising a suction hose connected laterally to the suction cup, wherein the suction hose is connected transversely to the longitudinal axis of the suction cup.

13. A cleaning device comprising:
a suction system comprising a suction cup having a base body with an outer circumference corresponding with an inner circumference of a hose filter opening, an opening, and a longitudinal axis;
a first felt seal attached to the outer circumference; and
a second felt seal secured to the inner circumference of the opening.

14. The cleaning device of claim 13, wherein the device is mobile.

15. The cleaning device of claim 13, further comprising a cleaning element guided through the through-opening of the suction cup and capable of transverse movement.

16. The cleaning device of claim 15, further comprising a cleaning head having at least one cleaning nozzle.

17. The cleaning device of claim 16, wherein the cleaning head and/or the at least one cleaning nozzle is set in rotation during operation.

18. The cleaning device of claim 13, further comprising a control unit for controlling the operation, wherein the control unit comprises a second foot pedal for activating and deactivating the cleaning device.

19. The cleaning device of claim 18, wherein the first and second foot pedals are unified.

20. A method for cleaning horizontally-installed hose filters, comprising:
providing a cleaning device comprising a suction system having a suction cup with a base body having an outer circumference corresponding with an inner circumference of a hose filter opening, a through-opening, a longitudinal axis, a first felt seal attached to the outer circumference, a second felt seal secured to the inner circumference of the through-opening, and a control unit to control the cleaning device;
securing the suction system with respect to an inner circumference of the hose filter opening;
introducing a cleaning element into the hose filter through the through-opening; and
moving the cleaning element in the hose filter.
